(19) United States
(12) Patent Application Publication
(10) Pub. No.: US 2003/0120745 A1
(43) Pub. Date: Jun. 26, 2003

(54) Information receiving system and information receiving terminal

(75) Inventors: Makoto Katagishi, Chigasaki (JP); Kenji Sano, Yokohama (JP); Osamu Hasegawa, Mito (JP); Tomonori Nomura, Zushi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/138,106

(22) Filed: May 3, 2002

(30) Foreign Application Priority Data
Dec. 26, 2001 (JP) 2001-393361

(51) Int. Cl. G06F 15/16

(52) U.S. Cl. 709/217

(57) ABSTRACT

The present invention makes possible smooth acquisition of product information from a server over a network and display of the information. A product is provided with an RFID. When the user operates a cellular phone to read information from the RFID, the phone calls the RFID by transmitting RF waves to it. Upon receiving response data from the RFID, the cellular phone extracts a server access address and product ID from the data without awaiting the user's instructions to acquire information, and automatically accesses the product information server, based on the server access address. The information acquired from the product information server is displayed on the cellular phone screen. Thereby, the user can promptly have the information about the product.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Technical Field of the Invention

The present invention relates to an information receiving system making it possible to provide cellular phones and personal digital assistants (PDAs) with a diversity of information, and information receiving terminals therefor.

2. Description of Related Art

A careful consumer checks catalogs, instruction manuals, and the like before buying product and tries to collect a diversity of information about the product that he or she wants to buy. Even after buying the product, the user may need some information, for example, a reference to contact should a fault occur or repair be required, information about the latest version, or information about improved goods. The user may obtain desired information by calling the contact number printed on the product, instruction manual, or the like, or by accessing the Web site of the supplier of the product (the manufacturer or vendor).

Conveying information about a product primarily depends on printed matter available at stores in the distribution market, such as catalogs and instruction manuals. However, because product information, maintenance-related information, and the like are periodically updated, or may be updated at any time, it is difficult for the supplier of a product to convey the latest information completely and rapidly to the buyer, user, or potential buyer. Recently, product suppliers have begun to print the URL of their Web site on catalogs and commodities and provide the latest product information on a network.

Meanwhile, as a technique used for product and logistics management, an identification device is known that generates its operating power from the received power of externally applied RF waves and transmits response signals carrying information stored on the device beforehand. One example is a mobile body identification device made public in RCR STD-1 or RCR STD-29, standard specifications defined by the Association of Radio Industries and Business (ARIB), which is generally referred to as Radio Frequency Identification (RFID). The RFID is a product comprising an antenna coil, memory, and other elements built in a thin small chip. The typical size of an RFID now being manufactured is about 0.5 mm thick and about I mm square. A method of product location management incorporating the RFID into a product and reading the information stored in the RFID at a specific location is disclosed in, for example, JP-A-116583/2001.

In a system disclosed in JP-A-273226/2001, the RFID is incorporated into a product and the URL of the Web site providing information about the product is stored in the RFID beforehand prior to sale. Based on the URL read by a tag reader, a terminal connected to the Internet can access the Web site.

In the technique described in JP-A-273226/2001, the system helps the user in accessing the Web site to facilitate distributing the latest product information. To access the desired Web site, however, the user must select the URL displayed on the terminal. Unless the user selects the URL in addition to requesting the RFID to send information, the user cannot obtain the desired information, and therefore, this technique has limitations in usability.

Generally, it takes some time before a terminal obtains information from the Web site, the length of time varying, according to factors such as network congestion, the data receiving speed of the terminal, and server processing capacity. As the wait time becomes longer, user dissatisfaction may increase. In this respect, the technique described in the above-mentioned publication leaves room for improvement.

Furthermore, upon request, the RFID unconditionally transmits the information stored thereon through the tag reader; therefore, it is impossible to provide a specific user with specific information. In this respect, the above technique has further limitations in usability.

### BRIEF SUMMARY OF THE INVENTION

It is an object of the present invention to provide an information receiving system and information receiving terminal that enable smooth information reception from a server with improved operability. It is another object of the present invention to provide an information receiving system and information receiving terminal that can improve user satisfaction by providing other information before acquiring information from the server. It is a further object of the present invention to provide an information receiving system and information receiving terminal enabling smooth information acquisition and presentation with better usability.

In order to solve the above-described problems, an information receiving system according to the present invention allows a terminal to automatically acquire information from the server, thereby performing seamless information provision.

An information transmitter comprises a first memory in which a server access address is stored prior to sale, and a response-sending unit for sending an information receiving terminal the server access address stored in first memory, in response to a request from the information receiving terminal. The information receiving terminal comprises an information-requesting unit that asks the information transmitter to send information; an information-acquiring unit that accesses the server, based on the server access address received from the information transmitter, and acquires posted information about an article; an information-presenting unit for presenting the acquired information; and a controller which starts a processing sequence that obtains and presents the desired information, and which controls the aforementioned components..

In a preferred embodiment, the information transmitter is configured as a mobile apparatus identification device that responds to a request to send information by using the received RF waves that carried the request as the power source, the RF waves now being transmitted from the information receiving terminal. More specifically, an RFID can be used as the information transmitter. The information transmitter, which is attached to or installed inside or placed in the proximity of one of a variety of articles such as consumer goods, transmits a signal or information relating to the article. If the information transmitted from the information transmitter clearly has a close relationship to the article, the information transmitter may be placed apart from the article.

The server access address can be exemplified by an URL that identifies a Web site or an information source within the site. The “posted information about the article” means information about the article provided by use of the information transmitter. The information may be about the article itself or about the supplier, the owner, or a person who writes information into the information transmitter. Information about the article itself includes, for example, features, performance, , delivery date, price, options, maintenance information, etc. Information about the supplier of the article and other commercially involved persons can be exemplified by the supplier's personal information (for example, name, title, address, , , email address, etc.) in relation to the article (for example, a business card).

A user who wants to obtain information about an article asks the information transmitter to send information, first by bringing his or her information receiving terminal close enough to the information transmitter that the terminal falls within the communication area range of the transmitter, and then by using predetermined buttons of the terminal, or giving spoken instructions. In response to the request from the information receiving terminal, the information transmitter returns the server access address. Upon receiving the server access address from the information transmitter, the information receiving terminal automatically starts the information-acquiring unit. Then, the posted information is acquired and the information is displayed by the information-presenting unit.

In the present invention, although a request for information to the information transmitter is made by the user, it is unnecessary for the user to perform another operation or to give explicit instructions for acquiring posted information. It should be noted that information is seamlessly acquired and made visible.

In the information receiving system according to another aspect of the present invention, associated information linked with posted product information is also stored prior to sale in the first memory of the information transmitter. The information receiving terminal receives posted product information and associated information from the information transmitter and makes the information-presenting unit present associated information together with posted product information.

The associated information message can be exemplified by short information about the article such as advertising messages, notice messages, and summaries. Because associated information is also stored in the information transmitter, a smaller quantity of message data is preferable. Like associated information, the attribute information about the article, information about the supplier, or the like, can be specified as described above.

The posted product information can be termed “detailed information” and the associated information “summary information.” Alternatively, the posted product information can be regarded as “related information” and associated information as “basic information.” Preferably, the posted product information and associated information complement each other as above.

Preferably, the information receiving terminal makes the information-presenting unit present associated information during a waiting period until the posted product information is acquired from the server.

In this manner, the user can obtain and check some information during the wait time and user satisfaction is enhanced.

n the information receiving system according to yet another aspect of the present invention, access control information for controlling information acquisition by the information receiving terminal is stored in the first memory. The response-sending unit sends information set as “inaccessible” by the access control information to the information receiving terminal when data to unlock access control has been entered from the information receiving terminal.

In short, access control is exercised to prevent the information stored in the information transmitter from being unconditionally accessible to the information receiving terminal. When the user issues a request for information to the-information transmitter or by request from the information transmitter, the user must enter data to unlock the access control, such as a password or personal identification number (PIN), which is then transferred to the information transmitter. It is possible to store the information to unlock the access control in the information receiving transmitter, so that this information will be automatically transferred from the information receiving terminal to the information transmitter by user operation or by request from the information transmitter.

In the information receiving system according to a further aspect of the present invention, article identifying information for identifying an article provided with the information transmitter is stored in advance in the first memory together with the server access address. The information-acquiring unit accesses said server on the network, based on the server access address, and acquires posted information about the article, based on the article identifying information.

The server searches its database, using the article identifying information as the search key, and can send the thus-located posted information about the article to the information receiving terminal. Alternatively, if the URL or Internet protocol (IP) address that identifies specific information within the Web site is specified as the article identifying information, the server can find the information about the article without a search and send it.

In the information receiving system according to a still further aspect of the present invention, the information receiving terminal includes a second memory in which terminal-identifying information for identifying the terminal itself is stored prior to sale. The information-acquiring unit links the identifying information and the terminal-identifying information and sends them to the server, where the information is stored..

In this manner, the server can identify the information receiving terminal. When new information is generated later, the server can immediately distribute it to the user without awaiting the next access from the information receiving terminal. Through data management in which terminal-identifying information is associated with article-identifying information, the data stored on the server can be used for user management and marketing.

In the information receiving system according to a still further aspect of the present invention, multiple information transmitters are installed on an article in multiple places, the first memory of each information transmitter having posted product information pre-stored therein, according to the place in which each transmitter is installed.

Products include those consisting of many functional parts, such as motor vehicles, aircraft, construction machines, buildings, kitchen equipment, and manufacturing facilities. For a product consisting of multiple functional parts, all parts or the main functional parts are provided with information transmitters. Each information transmitter contains pre-stored information about the function of the part provided with the transmitter. Alternatively, the server address for accessing function-related information may be stored in each information transmitter.

According to a still further aspect of the present invention, the invention provides a method for providing product information, using a storage device that is able to transmit information stored thereon and which is attached to a product. This method comprises the steps of storing in said storage device product-identifying information and information for accessing a product-information server; reading information from the storage device upon request from a terminal device; transferring the product-identifying information to the-terminal device; causing the terminal device to access the product-information server; distributing product information from the product-information server to the terminal device; and storing information identifying the terminal device in the product-information server, so that the product-information server can access the terminal device.

It is understandable that the present invention is implemented as control programs for controlling the operations of the information transmitter and information receiving terminal as well as the product-information providing system.

### BRIEF DESCRIPTION OF THE DRAWINGS

FIG. 1 is a conceptual diagram showing the overall structure of an information receiving system according to a first embodiment of the present invention;

FIG. 2 is a flowchart illustrating the process of acquiring and presenting information in Embodiment 1;

FIG. 3 illustrates examples of displaying processing status during the process of acquiring and presenting information, wherein (a) is a display example when the phone is receiving response signals from the RFID; and (b) is another display example when the phone is automatically accessing the product information server;

FIG. 4 illustrates a display example following the display example in FIG. 3 (b) when the phone has acquired product information from the product information server;

FIG. 5 is a conceptual diagram showing the overall structure of an information receiving system according to a second embodiment of the present invention;

FIG. 6 illustrates an example of user database organization;

FIG. 7 is a flowchart illustrating the process of acquiring and presenting information in Embodiment 2;

FIG. 8 is a conceptual diagram showing the overall structure of an information receiving system according to a third embodiment of the present invention;

FIG. 9 is a flowchart illustrating the process of acquiring and presenting information in Embodiment 3;

FIG. 10 illustrates examples of displaying a product summary during a waiting period before detailed product information is acquired, wherein (a) exemplified the display of a product summary during the wait time; and (b) exemplifies a display when connection to the product information server has been made after the waiting period has expired;

FIG. 11 is a conceptual diagram showing the overall structure of an information receiving system according to a fourth embodiment of the present invention;

FIG. 12 illustrates exemplary personal information items to which access control is applied, (a) exemplifying a display wherein personal items are set as accessible or inacessible, including years of service and work history; and (b) exemplifying another display wherein different items (place of work, hobby) from those in (a) are set;

FIG. 13 illustrates an example of a display shown when entering personal information items to be stored in the RFID, some of which are set for access control;

FIG. 14 is a flowchart illustrating the process of acquiring and presenting information in Embodiment 4;

FIG. 15 is a flowchart illustrating the process of acquiring and presenting information according to a fifth embodiment of the present invention;

FIG. 16 is an illustration concerning a sixth embodiment of the present invention, wherein multiple RFIDs are respectively installed on main functional parts of an item;

FIG. 17 is an illustration of installation of the antenna coil, a seventh embodiment of the present invention, wherein (a) antenna coil installation at the top in the rear of the terminal; (b) antenna coil installation inside one side surface of the terminal; and (c) antenna coil installation under the top surface of the terminal; and

FIG. 18 is a conceptual diagram showing the overall structure of an information receiving system according to an eighth embodiment of the present invention.

### DESCRIPTION OF THE PREFERRED EMBODIMENTS

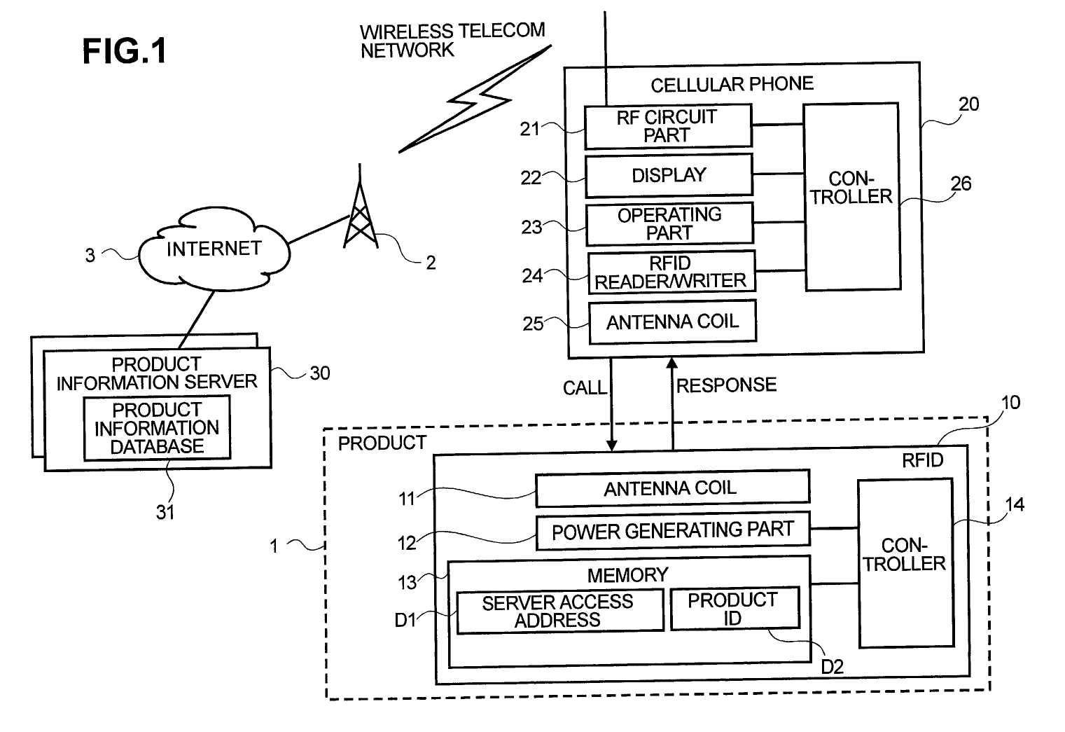

The present invention now is described more fully with reference to the accompanying drawings, FIGS. 1 to 18, in which preferred embodiments of the invention are shown.

A preferred Embodiment 1 of the invention is now described with reference to FIGS. 1-4. FIG. 1 is a block diagram showing the overall outline of an information receiving system according to Embodiment 1. This system essentially includes an RFID 10 as an information transmitter, a cellular phone 20 as an information receiving terminal, and a product-information server 30. These elements will be fully described later.

An illustrative product 1 is any item of commercial goods of various kinds including food, medicines, stationery, electric appliances, machines, motor vehicles, etc. Product 1 is provided with a RFID 10 containing product-related information. It is possible to install RFID 10 inside the product or on its surface, or to attach it to the packaging, or the like.

RFID 10 includes an antenna coil 11, a power generation part 12, a memory 13, and a controller 14. When cellular phone 20 transmits RF waves carrying a request to send information and antenna coil 11 receives the RF waves, power generation part 12 generates required power by taking advantage of the induced electromotive force. Controller 14 reads information consisting of server access address (D1) and product ID (D2), which have been stored in memory 13, and makes the RFID return response signals carrying the above information to cellular phone 20 through antenna coil 11.

Cellular phone 20 includes a RF circuit part 21, a display 22, an operating part 23, a RFID reader/writer 24, an antenna coil 25, and a controller 26. Controller 26 controls the operation of the above components of the cellular phone. Although cellular phone 20 is used as the information receiving terminal in Embodiment 1, a personal digital assistant (PAD) may be used instead. Alternatively, any other terminal device capable of communicating with both the RFID and the server may be used as the information receiving terminal.

RF circuit part 21 performs the function of bi-directional radio communication between the cellular phone and a base station 2 for radio communication. Display 22 performs the function of displaying data such as characters and images. Operating part 23 comprises buttons and a stick-like pointing device or the like, and receives input by the user. RFID reader/writer 24 as an information-acquiring unit has a function of receiving response signals from RFID 10 via antenna coil 25 and a function of storing information into RFID 10.

It is preferable that RFID reader/writer 24 is built into cellular phone 20 in consideration of carrying the RFID. By initial design, cellular phone 20 can be configured to include RFID reader/writer 24 in the phone's hardware. Alternatively, RFID reader/writer 24 can be made attachable to the phone, for example, in a card form that can be attached to cellular phone 20 later, when necessary. The information-acquiring unit should be provided with at least an RFID reader function and need not have a write function if storing information in RFID 10 is not necessary. Installation of antenna coil 25 will be described later in another preferred embodiment.

Product information server 30 connects to the Internet 3. Product information server 30 is able to perform bidirectional data communication with cellular phone 20 via base station 2 for radio communication. Product information server 30, which includes a product information database 31, maintains and manages information for various items, each item being associated with a product ID stored in RFID 10.

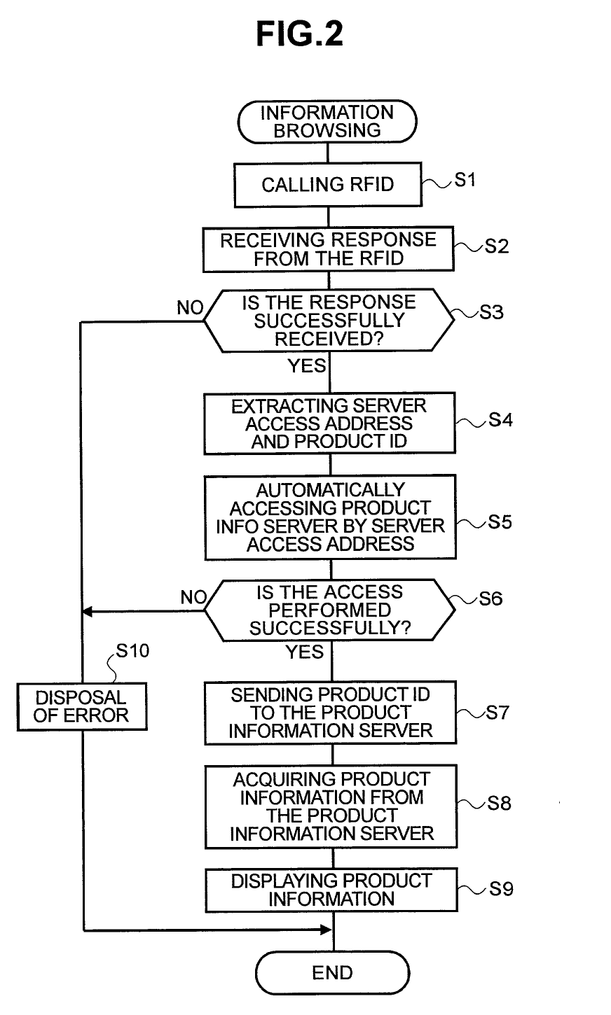

Next, with reference to the flowchart shown in FIG. 2, the process of acquiring and presenting information as carried out by cellular phone 20 is explained.

When the user performs a predetermined operation using operating part 23, this process starts; for example, the user presses one or more predetermined buttons or orally instructs the phone to start the process. This operation triggers a request for information and triggering can be set in advance to occur by default or can be optionally set by the user. For example, when the user sets triggering beforehand so that controller 26 of cellular phone 20 automatically asks RFID 10 for information, a trigger signal is periodically sent to the RFID to request it to send information. From a power consumption viewpoint, it is preferable to start this process with an operation explicitly instructed by the user.

When the user performs an operation to make a request for information, RFID reader/writer 24 transmits RF waves through antenna coil 25, thus calling RFID 10 (S1). Using the received power of the RF waves from cellular phone 20 as the power source, RFID 10 generates and returns response signals to the phone (S2). During one request for information, RFID reader/writer 24 can call RFID 10 multiple times.

When the phone successfully receives the response signals from RFID 10 (S3,YES), the phone extracts the server access address (hereinafter address information) and product ID from the response signals (S4). If the phone fails to receive the response even after a predetermined number of attempts to call the RFID, the phone returns an error (S10). To notify the user of the error occurrence, the phone displays an error message or may alert the user by sound, by vibration, or by light.

Upon obtaining the address information, cellular phone 20 automatically accesses product information server 30 (S5). It should be noted that the user is not required to select address information and perform some operation to start the access: the phone automatically accesses the product information server 30. When connection to the product information server 30 is successful and a communication path has been established (S6, YES), the phone sends the product ID received from RFID 10 to the product information server (S7). Product information server 30 searches product information database 31 for a product identified by the product ID, reads the information associated with the product 1, and returns that information to the cellular phone (S8). Cellular phone 20 displays the product information acquired from product information server 30 on the display 22 (S9).

From the viewpoint of communication time and charges, a small quantity of data as the product information set is desirable. Thus, it is preferable that the product information consists of text data. However, the product information may include still images, motion video, audio data, etc.

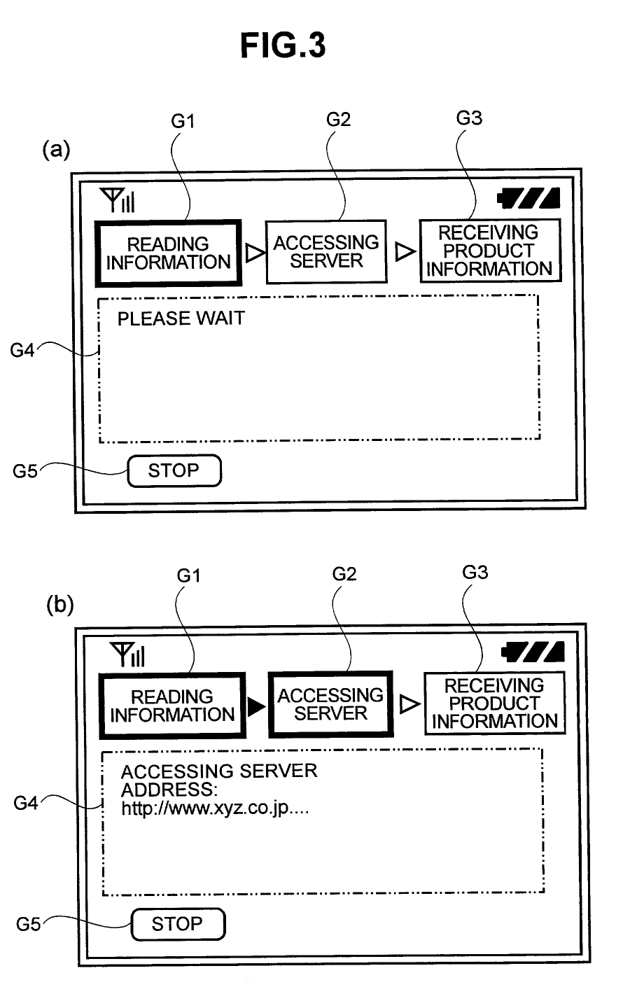

FIG. 3 illustrates examples of showing processing status on the display of the cellular phone 20. At the top of the display, the status of each step (procedure) to be executed until the information is obtained is shown in status boxes G1 to G3. When a step is in process, its status box is inverted, highlighted, or blinks. As the steps are executed, their status boxes G1 to G3 change in appearance. In a display area G4, a message and supplemental data can be displayed. When the user selects Stop button G5, the processing is aborted.

FIG. 3(a) is an example of a display when the phone is receiving response signals from the RFID 10. At the top of the display, status box G1 is highlighted. A message “Please Wait” is shown in display area G4.

FIG. 3(b) is an example of a display when the phone is automatically accessing product information server 30 following reception of the response signals. Upon completion of reading information from RFID 10, the step of automatically connecting to product information server 30 immediately begins when status box G2 is the most brightly highlighted. In display area G4, the URL (address) of product information server 30 that the phone is accessing is displayed, so that the user can make sure that the phone is accessing the server.

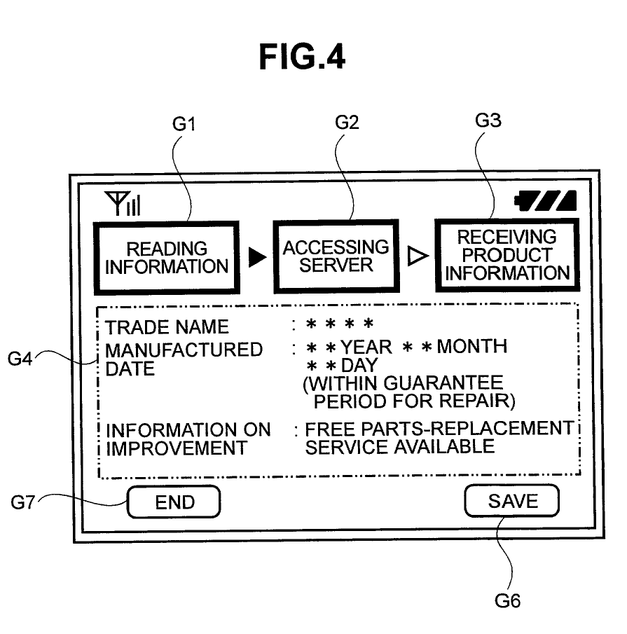

FIG. 4 illustrates an example of a display that follows the display example in FIG. 3(b) during the step of automatically connecting to the product information server. In FIG. 4, when the phone has acquired the desired product information from the product information server 30, status box G3 is the most brightly highlighted. In display area G4, the acquired product information is displayed. By selecting Save button G6, the user can store the product information in the memory of cellular phone 20. When the user selects End button G7, the product information presenting display can change to another display such the display for awaiting a call. A Clear button may be added to clear the display immediately after the product information is presented so that memory space can remain empty.

The product information can include such things as the name of a product, the date when the product was manufactured, the latest information about the product, maintenance information, etc. To make effective use of the limited display panel size, it is also possible to display the items in hierarchical structure so that the user can select an item and view its detailed information.

The information receiving system of Embodiment 1 is configured as described above. In this system, when cellular phone 20 reads the address information and product ID from RFID 10, it immediately accesses product information server 30, without awaiting the user's specific directions, and acquires product information. Compared to the previous techniques of providing information by means of RFID, the present system enables smoother acquisition and presentation of product information (in the eyes of the user, browsing of product information) and improves the RFID usability.

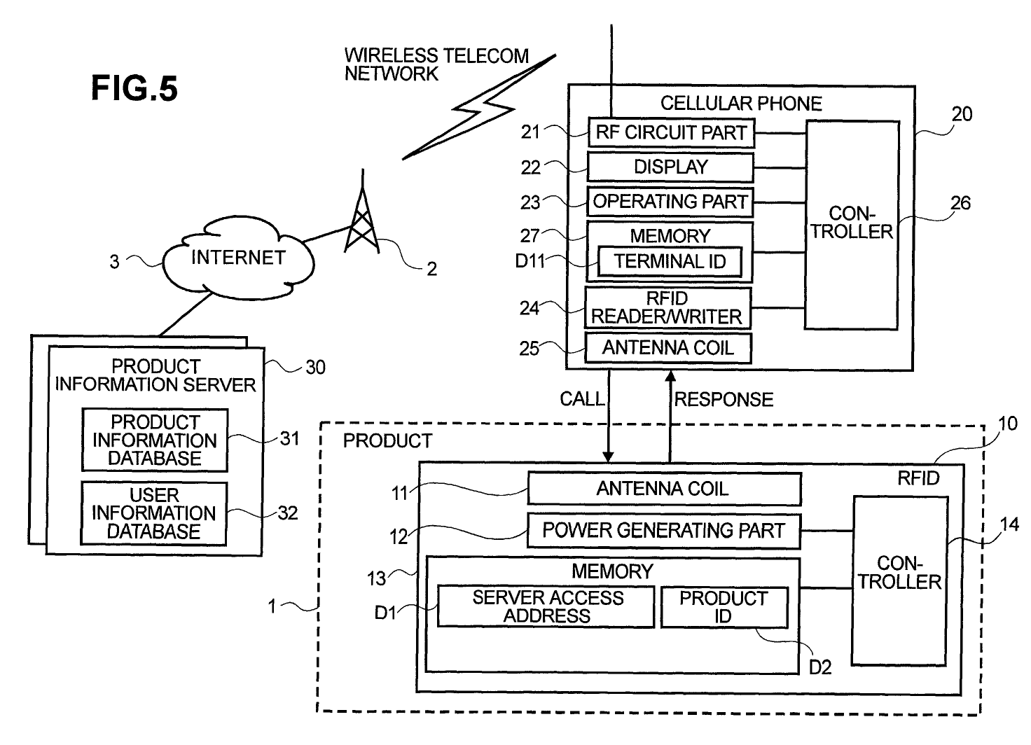

Next, a second embodiment of the present invention is described, using FIGS. 5 to 7. In the following, the components corresponding to the above-described components are assigned the same reference numbers and the explanation thereof will not be repeated. Features of Embodiment 2 are storing the terminal ID in the memory of cellular phone 20 in advance, and linking the terminal ID and product ID when the phone requests the product information from server 30.

Memory 27 of cellular phone 20 is embodied in, for example, a nonvolatile memory in which a specific terminal ID (D11) for identifying cellular phone 20 is pre-stored. Memory 27 can be installed as a basic part of cellular phone 20 by its initial hardware design or may be embodied in a recording medium such as a memory card that can be installed and removed when necessary. Cellular phone 20 links the terminal ID and the product ID when requesting product information from the product information server 30. Cellular phone 20 sends product information server 30 the terminal ID and the product ID together in order that the server can identify the destination to which it is to return the product information.

Product information server 30 includes a user database 32. The user database 32 is provided for management in which a product ID is associated with a terminal ID for all product items stored on the server. Once the terminal ID and product ID sent from the cellular phone have been stored in the user database 32, product information server 30 can provide diverse services in response to the user's later query about product information; for example, providing information, whereupon the information items are displayed in different order, or sending e-mail notice of updated product information to the user. The user database can [also?] be used for keeping the access count per user and marketing.

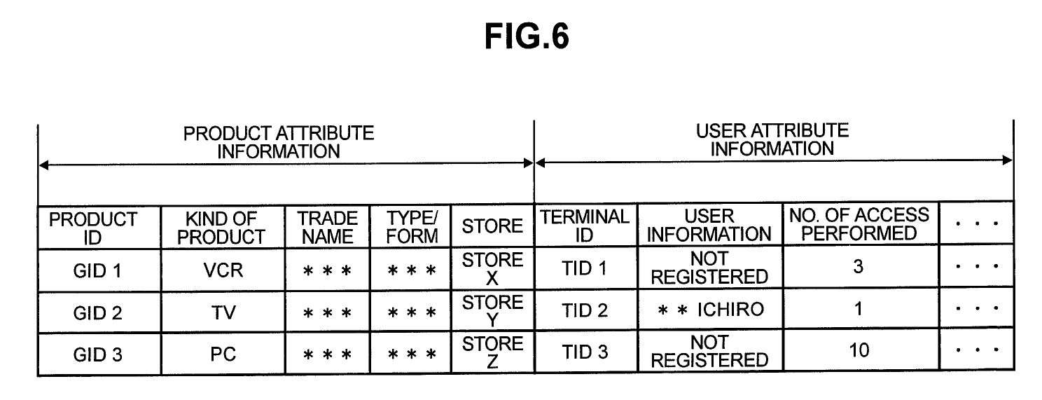

User database 32 can be organized in table form, as shown in FIG. 6, for example. The table as user database 32 contains the management data, for all items stored on the server, in which product attribute information specific to a product ID is associated with user attribute information specific to a terminal ID. The product attribute information includes, for example, product ID, kind of product, trademark, type, date of manufacture, maintenance validity term, distribution route, standard time limit for delivery, stock, etc. The user information includes, for example, terminal ID, personal information (name, telephone number, etc.), access count, etc. By using user database 32, for example, it is possible to infer what the user takes interest in or how much buying power the user has or to predict time when the user will want to buy a new product replacing the old one. The database can be made useful in developing active sales strategies.

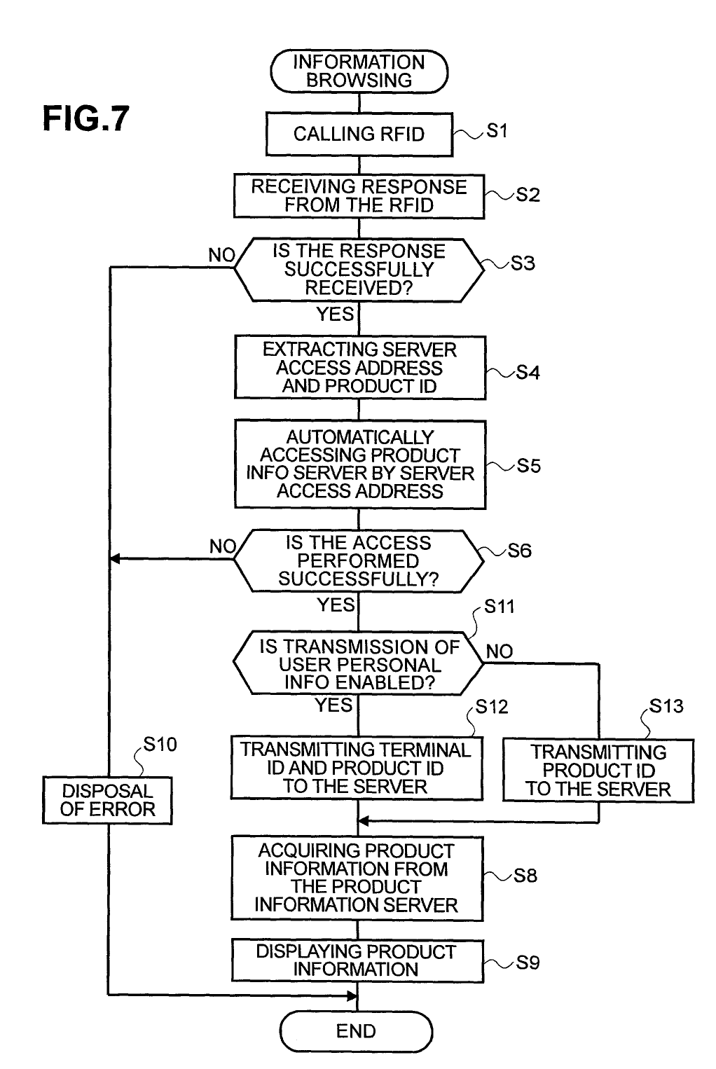

FIG. 7 is a flowchart illustrating the process of acquiring and presenting information according to Embodiment 2. During this process, when the connection to the product information server 30 has been established or the access is successful (S6, YES), the cellular phone determines whether sending of user personal information (including the terminal ID) to product information server 30 is enabled (S11). The user can set the cellular phone in advance to enable/disable sending personal information. Alternatively, the cellular phone may display a message asking the user whether to enable sending personal information..

When sending personal information is enabled (S11, YES), the cellular phone sends the linked terminal ID and product ID to product information server 30 (S12). For example, the cellular phone sends the product ID immediately followed by the terminal ID. When sending personal information is disabled (S11, NO), the cellular phone sends only the product ID to product information server 30 (S13). Because the user can choose whether to enable sending personal information (name, terminal ID, etc.), usability is even more improved.

Instead of sending the terminal ID and the product ID as they are to product information server 30, portable phone 20 can internally generate a new ID in which the terminal ID and the product ID are combined and can send this ID to product information server 30. Product information server 30 extracts the product ID and the terminal ID from this combined ID and stores them in user database 32.

By having the terminal ID registered on the product information server in this way, product information server 30 can access cellular phone 20 and send the user information of various kinds at a different time from that of providing the cellular phone 20 with product information.

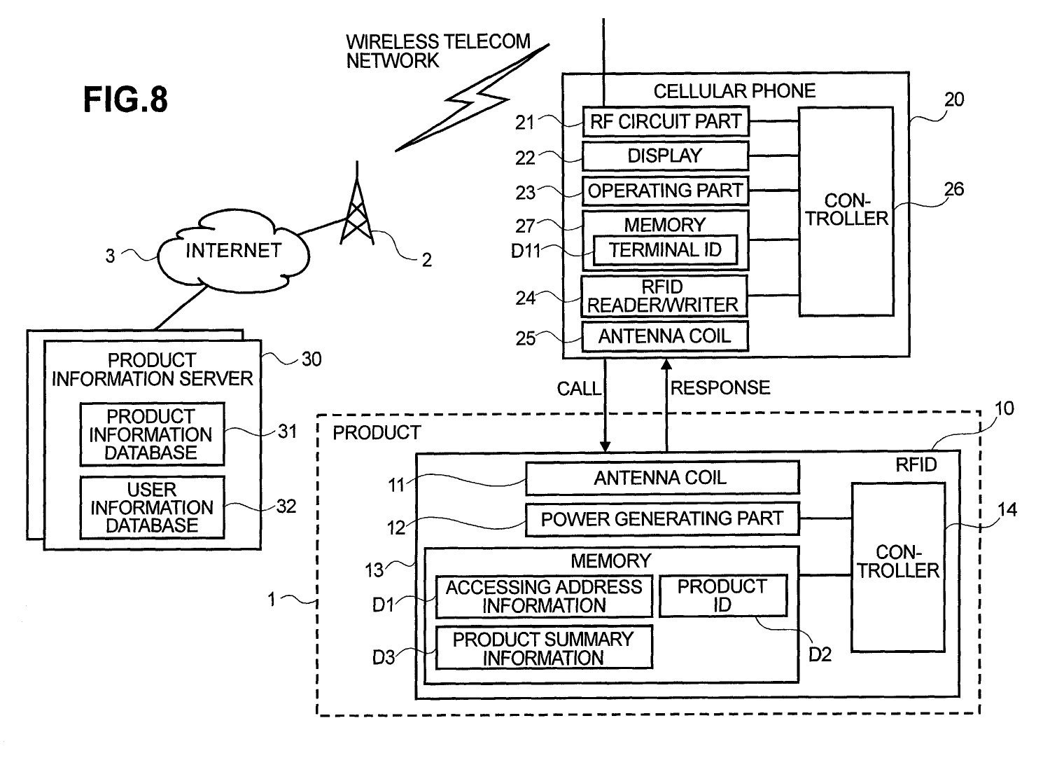

A third embodiment of the present invention is now described with reference to FIGS. 8 to 10. As shown in FIG. 8, the features of Embodiment 3 are the ability to prestore product summary information D3 (hereinafter product summary) in RFID 10 separately from the product information and the ability to present the product summary to the user when the cellular phone is waiting to obtain product information from the server.

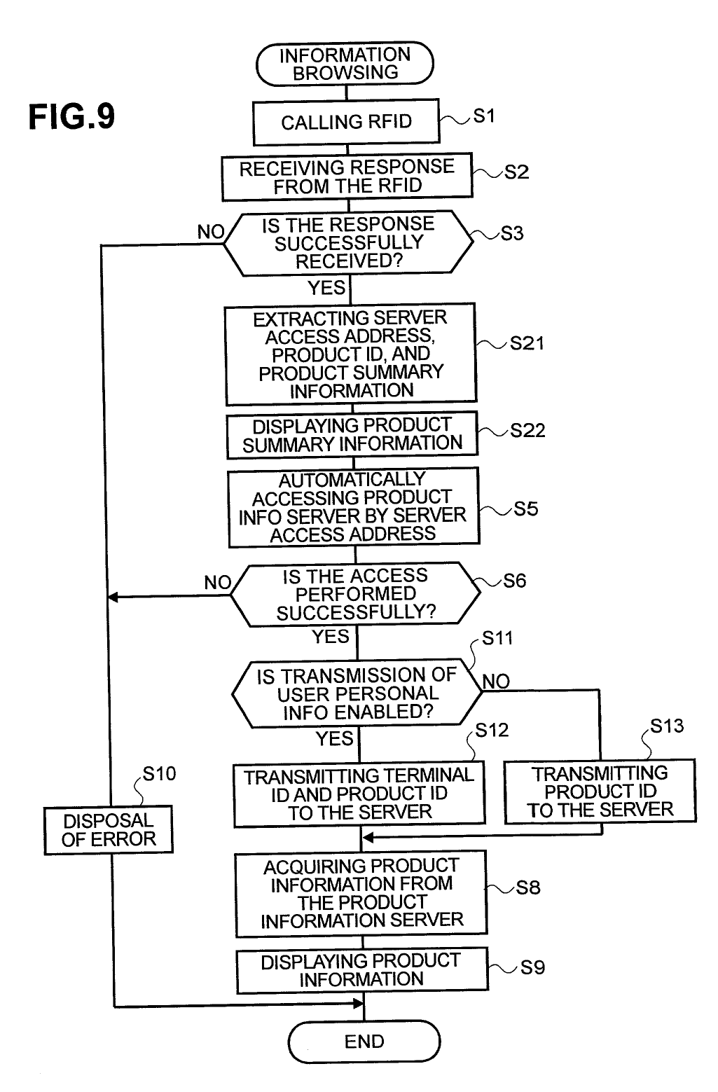

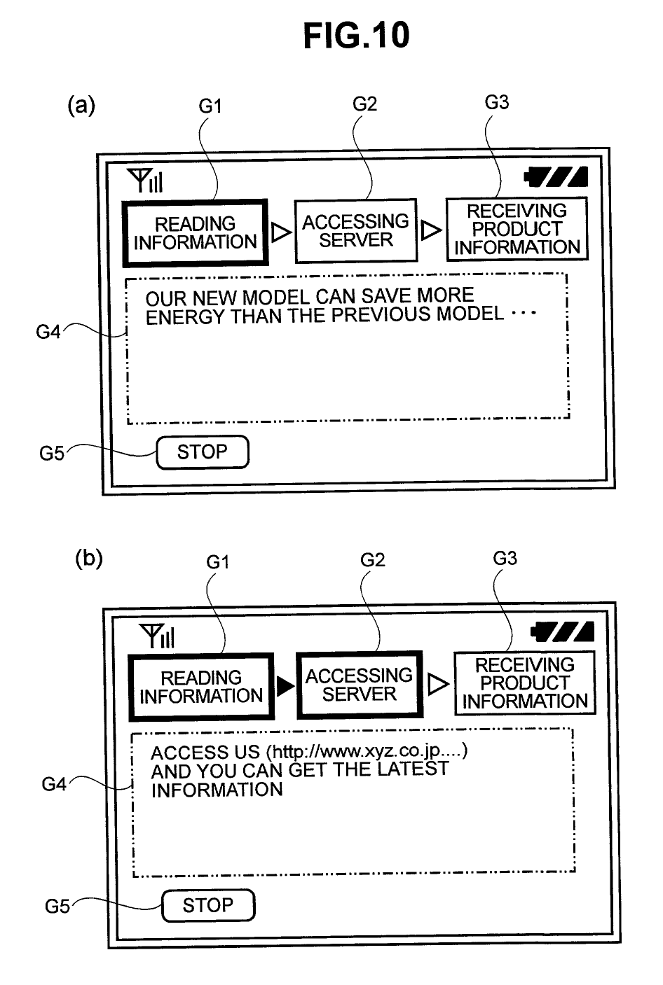

Referring to the flowchart of the process illustrated in FIG. 9, cellular phone 20 reads the product summary in addition to the address information and product ID from RFID 10 (S21). The product summary can be provided, for example, as a brief description of the main product features. As illustrated in FIG. 10(a), that type of product summary is immediately displayed in display area G4 of display 22 while the cellular phone is waiting to obtain product information from the server (S22). Thus, the user can check the product summary, making effective use of the wait time before further detailed product information is obtained from product information server 30. Consequently, usability and user satisfaction are improved. When the connection to the product information server has been made, the server information shown in display area G4 is as illustrated in FIG. 10(b).

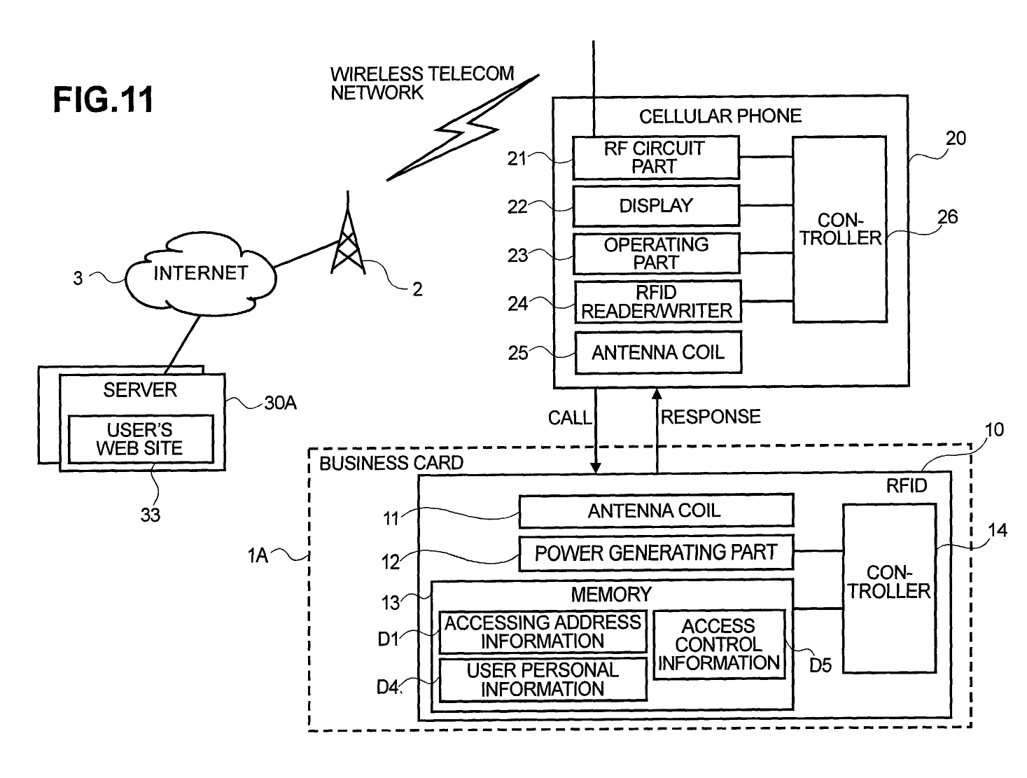

A fourth embodiment of the present invention is now described, with reference to FIGS. 11 to 14. A feature of Embodiment 4 is applying access control to information that cellular phone 20 reads from RFID 10.

In Embodiment 4, a business accessory that provides personal information, for example, a business card 1A, or the like, is treated in the same manner as product 1 of the first embodiment. Diverse information that is supplemental to information on the business card is stored in RFID 10. Thus, a person who received the card can refer to further detailed information by so instructing his or her cellular phone 20.

In the memory 13 of RFID 10, personal information (D4) is stored in lieu of the product ID, and access control information (D5) has been stored beforehand. Controller 14 causes the RFID to send cellular phone 20 only the items of personal information that have been approved for transmission, based on the access control information.

In Embodiment 4, instead of product information server 30, a server 30A stores, for example, the address of a personal Web site 33 of the user (the person to which the business card belongs).

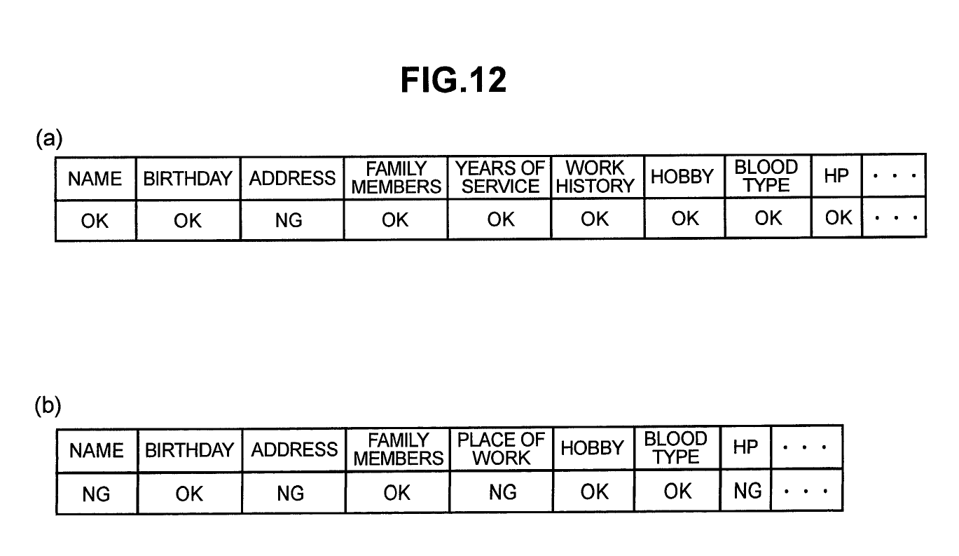

FIG. 12 illustrates exemplary personal information items to which access control is applied. The personal information includes such items as name, birthday, address, family members, occupation, years of service, work history, hobby; blood type, URL of the personal Web site, nickname, etc. For each of these items, the information provider can enable or disable access for transmission. As illustrated in FIGS. 12(a) and (b), information items can be organized as desired.

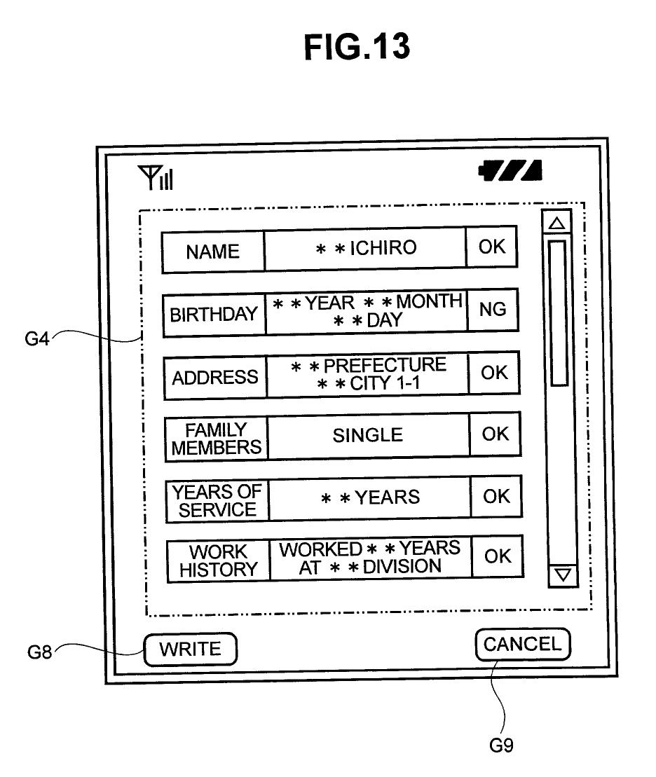

FIG. 13 is an example of a display shown when using RFID reader/writer 24 to enter personal information items stored in RFID 10 of business card 1A that require access information.

The user can set each item of personal information as accessible or not accessible (not for sending). When the user selects Write button G8, the personal information with access control information is stored in memory 13 of RFID 10 through RFID reader/writer 24. When the user selects Cancel button G9, the entered information is canceled. Although it is possible to store only the information items set as “accessible” in memory 13 of RFID 10, all personal information items are stored in RFID 10 in Embodiment 4 so that the personal information can be provided to the person who has preset information that unlocks the access control.

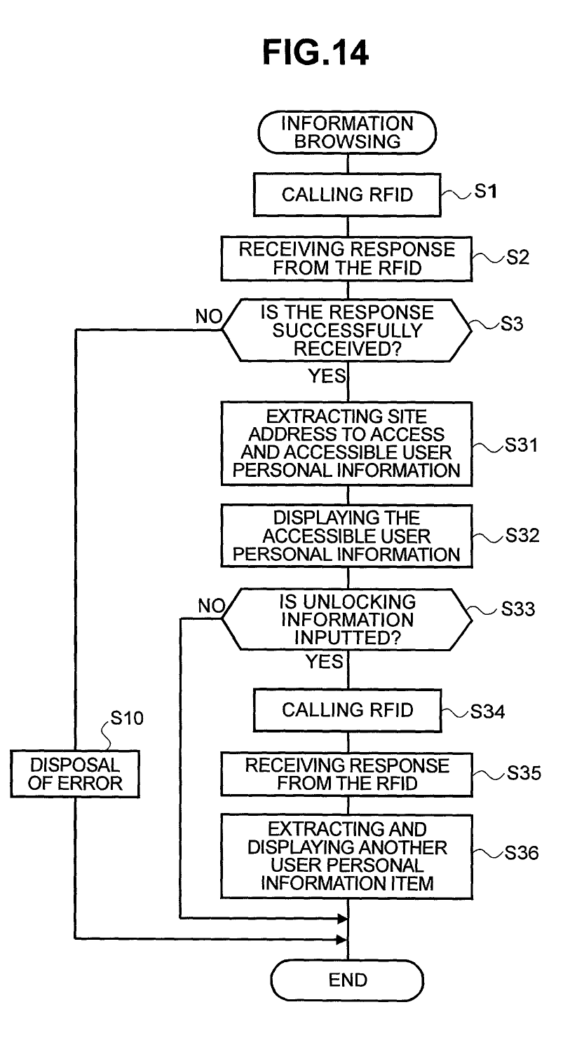

FIG. 14 is a flowchart illustrating the process of acquiring and presenting information according to Embodiment 4. When reading information from RFID 10 is successsful (S3, YES), cellular phone 20 extracts the site address to access and obtains only the accessible personal information items (S31). If the site address to be accessed (the URL of the personal Web site 33) is not accessible, cellular phone 20 cannot gain access to personal Web site 33.

Display 22 of cellular phone 20 first shows the accessible personal information items (S32). If the user has information to unlock the access control, such as a password or PIN, and enters that information (S33, YES), cellular phone 20 then resumes communicating with RFID 10 and reads the remaining information items that were set as inaccessible (S34, S35). The newly read information items are shown on display 22 of cellular phone 20 (S36).

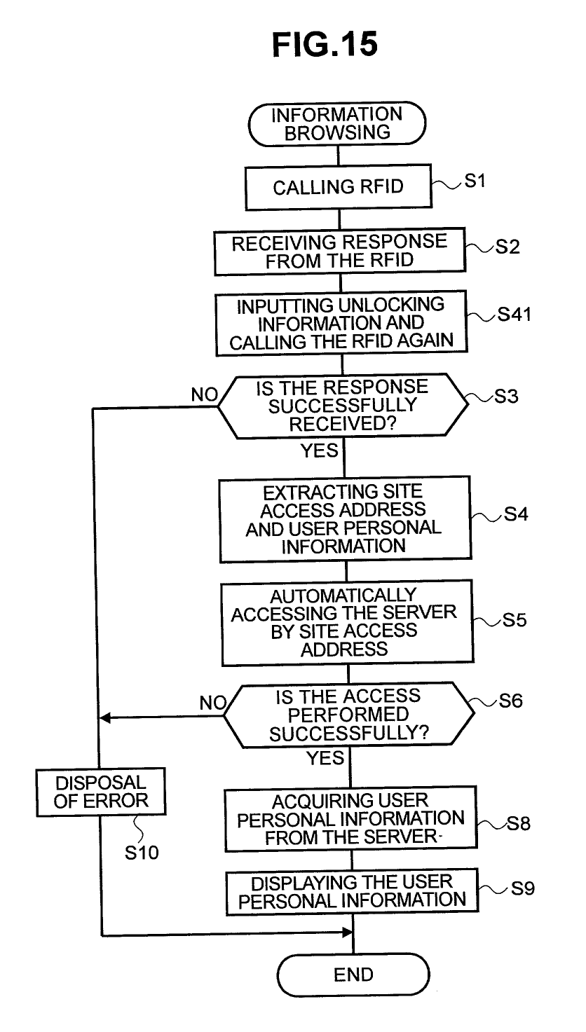

A preferred fifth embodiment of the present invention is now described using FIG. 15. A feature of Embodiment 5 is that the user enters the information to unlock the access control when calling the RFID to read personal information (S41). Using the site address to access, cellular phone 20 automatically accesses personal Web site 33 and acquires detailed personal information (S4 to S9).

Step S41 may be executed prior to step S1. In other words, after the user enters the information to unlock the access control, RFID 10 may be directly called to requesting it to send information.

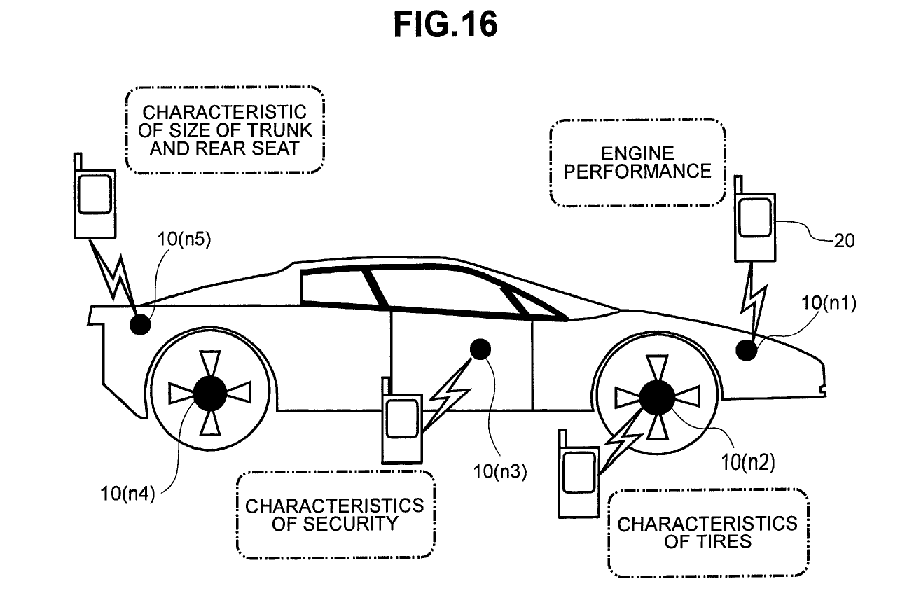

A sixth embodiment of the present invention is now described using FIG. 16.

Embodiment 6 applies to a product consisting of many functional parts in which RFIDs 10 are attached to the main functional parts. In each RFID 10, the address information has been pre-stored so that detailed information about the part to which it is attached can be acquired from the server. With this embodiment, detailed information for complex and large commodities such as motor vehicles, aircraft, ships, and construction machines, can be provided in hierarchical structure, wherein the information specific to the main functional parts thereof can be provided according to the positions of the parts in the three-dimensional space.

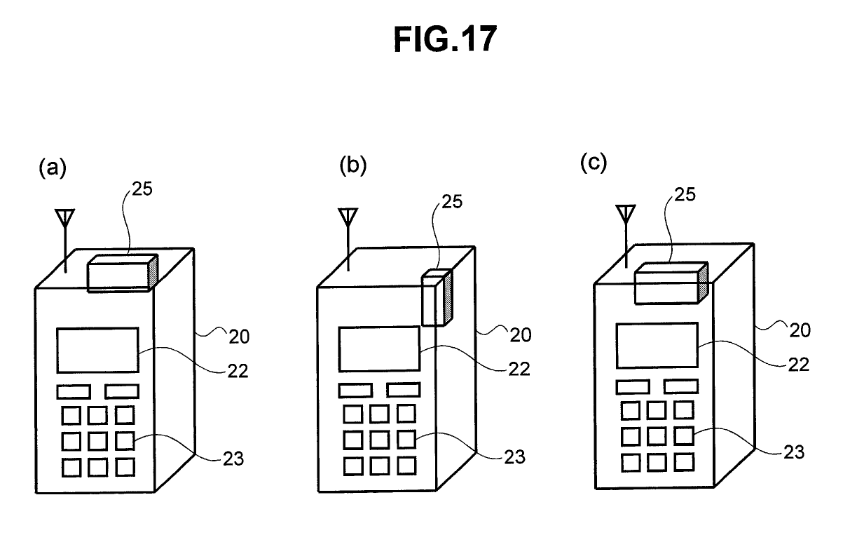

Next, a seventh embodiment of the present invention is described using FIG. 17.

Embodiment 7 concerns the installation of the antenna coil 25. FIG. 17 shows preferable positions for the antenna coil installation in cellular phone 20 for reading information from RFID 10. In each of these figures, antenna coil 25 is installed within the casing of cellular phone 20. FIG. 17(a) shows antenna coil 25 installed inside the surface opposite to the surface having display 22 and operating parts 23; that is, in the rear of the cellular phone 20. In particular, it is preferable to install antenna coil 25 at the top in the rear of the cellular phone to reduce or minimize the effect of the user's hand holding cellular phone 20. This can make it easy for the cellular phone to read information from RFID 10 while the user views the display and performs an operation.

Antenna coil 25 may be installed in other positions. For example, as shown in FIG. 17(b), the antenna coil can be installed at the top inside a side surface of the cellular phone. Alternatively, as shown in FIG. 17(c), antenna coil 25 may be installed just under the top surface of cellular phone 20. These positions allow the cellular phone to easily read information from RFID 10 while the user views the display and performs an operation. If this condition is fulfilled, the antenna may be installed in any position other than the positions shown in FIG. 17.

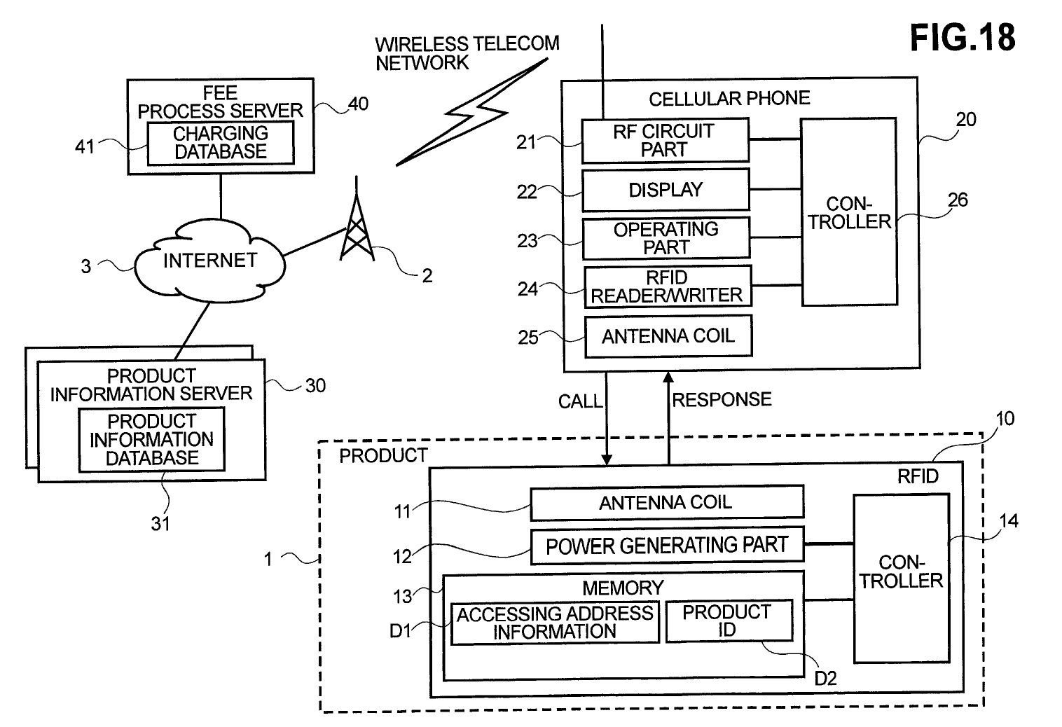

An eighth embodiment of the present invention is now described using FIG. 18. A feature of Embodiment 8 is that the product supplier pays the charge for cellular communication for sending product information from product information server 30 to cellular phone 20, and the user accessing the server is not charged.

A fee server 40 having a fee database 41 charges for communication between cellular phone 20 and product information server 30, according to the duration of communication. However, when fee server 40 finds that the cellular phone that has accessed product information server 30 has been registered beforehand on the server, it does not charge the user of the phone a communication fee. Instead of the user, the product information provider pays the communication fee for distributing the product information.

The above-described preferred embodiments are intended to be illustrative of the present invention and not restrictive. Those skilled in the art to which the invention pertains, know that the embodiments can be modified in several ways by adding new components to the configurations described, or by removing or altering some components.

For example, the present invention can apply to various kinds of merchandise, such as greeting cards, direct mail, fliers, newspapers, and books, besides the manufactured goods and business cards of the embodiments presented here. Encryption processing may apply to important information such as the personal information.

As described in detail above, according to the present invention, based on the information received from the information transmitter, the receiving terminal can immediately and automatically access the server, and therefore, usability and operability are improved.

What is claimed is:

1. An information receiving system comprising:
an information transmitter for transmitting information linked with an article; and
an information receiving terminal for accessing a server on a network, based on the information received from the information transmitter,
wherein
said information transmitter comprising:
a first memory in which a server access address for accessing said server is stored; and
a response-sending unit for sending said information receiving terminal said server access address stored in said first memory in response to a request from said information receiving terminal,
said information receiving terminal comprising:
an information-requesting unit for requesting said information transmitter to send information;
an information-acquiring unit for accessing said server, based on said server access address received from said information transmitter for acquiring posted information about said article;
an information-presenting unit for presenting said posted information acquired; and
a controller which starts said information-acquiring unit automatically accessing said server upon receiving said server access address from said information transmitter and which causes said information-acquiring unit to acquire said posted information and said information-presenting unit to present said posted information in a processing sequence.

2. An information receiving system according to claim 1, wherein:
said first memory stores associated information linked with said posted information beforehand; and
said information receiving terminal receives said posted information and said associated information from said information transmitter and causes said information-presenting unit to present said associated information together with said posted information.

3. An information receiving system according to claim 2, wherein:
said information receiving terminal is controlled so as to display said associated information on said information-presenting unit during a waiting period until said posted information is acquired from said server.

4. An information receiving system according to claim 1, wherein:
said first memory further stores access control information for controlling information acquisition by said information receiving terminal; and
said response-sending unit sends information set as inaccessible by said access control information to said information receiving terminal when information to unlock access control has been entered from said information receiving terminal.

5. An information receiving system according to claim 1, wherein:
said first memory pre-stores article identifying information for identifying an article provided with said information transmitter together with said server access address; and
said information-acquiring unit accesses said server on the network, based on said server access address, and acquires posted information about said article, based on said article identifying information.

6. An information receiving system according to claim 5, wherein:
said information receiving terminal includes a second memory in which terminal-identifying information for identifying the terminal itself is stored beforehand;
said information-acquiring unit links said article-identifying information and said terminal-identifying information and sends them to said server; and
said server stores said article-identifying information associated with said terminal-identifying information.

7. An information receiving system according to claim 6, wherein:
said article identifying information is an IP address.

8. An information receiving system according to claims 1, wherein:
a plurality of said information transmitters are installed on said article in a plurality of places respectively, the first memory of each information transmitter having said posted information stored therein, according to the place in which each transmitter is installed.

9. An information receiving system according to claims 1, wherein:
said information transmitter is a mobile apparatus identifying device that returns a response to request, using the received power of RF waves carrying the request to send, transmitted from said information receiving terminal, as a power source.

10. An information transmitter that is placed in relation to an article for transmitting information in response to a request from an information receiving terminal, said information transmitter comprising:
a memory in which a server access address to be used for the information receiving terminal to access a server on a network and to access associated information linked with posted information stored on said server; and
a response-sending unit for sending said information receiving terminal said server access address and said associated information stored in said memory in response to a request from said information receiving terminal.

11. An information transmitter according to claim 10, wherein:
said memory further stores access control information for controlling information acquisition by said information receiving terminal; and
said response-sending unit sends information set inaccessible by said access control information to said information receiving terminal when information to unlock access control has been entered from said information receiving terminal.

12. An information receiving terminal that accesses a server on a network, based on information received from an information transmitter that is provided as a communication extension to a particular article, said information receiving terminal comprising:
an information-requesting unit for requesting said information transmitter to send information;
an information-acquiring unit for accessing said server, based on the server access address received from said information transmitter, and acquiring posted information about said article;
an information-presenting unit for presenting said posted information acquired; and
a controller which starts said information-acquiring unit automatically accessing said server upon receiving said server access address from said information transmitter and which causes said information-acquiring unit to acquire said posted information and said information-presenting unit to present said posted information in a processing sequence.

13. An information receiving terminal according to claim 12, wherein:
said information receiving terminal receives other associated information linked with said posted information from said information transmitter and allows said information-presenting unit to present said other associated information during a waiting period until said information-acquiring unit acquires said posted information from said server.

14. An information receiving terminal according to claim 12, wherein:
said information receiving terminal includes a memory in which terminal-identifying information for identifying the terminal itself is stored beforehand; and
said information-acquiring unit sends said terminal-identifying information to said server when accessing said server to acquire said posted information from said server.

15. An information receiving terminal according to claim 12, wherein:
said request-to-send issuing unit sends information to unlock access control to said information transmitter to make the information set inaccessible by access control accessible so that said information transmitter will send that information.

16. An information receiving terminal according to claim 12, further comprising an information-writing unit for storing information into said information transmitter.

17. An information receiving terminal according to claim 12, wherein an antenna of said request-to-send issuing unit is installed such that said information-presenting unit is visible to the user of the terminal when said request-to-send issuing unit issues a request for information to said information transmitter.

18. A product information providing system comprising an information transmitter that is provided as a communication extension to a product and an information receiving terminal that accesses a server on a network, based on information received from said information transmitter,
wherein
said information transmitter comprises:
a first memory in which a server access address for accessing said server is stored beforehand; and
a response-sending unit for sending said information receiving terminal said server address to access stored in said first memory in response to a request from said information receiving terminal,
said information receiving terminal comprising:
an information-requesting unit for requesting said information transmitter to send information;
an information-acquiring unit for accessing said server, based on said server access address received from said information transmitter, and for acquiring detailed information about said product;
an information-presenting unit for presenting said detailed information acquired; and
a controller which starts said information-acquiring unit automatically accessing said server upon receiving said server access address from said information transmitter and which causes said information-acquiring unit to acquire said detailed information and said information-presenting unit to present said detailed information in a processing sequence;
said product information providing system including a fee server characterized in that, said server stops the fee-charging process to said information receiving terminal when it provides said information receiving terminal with said detailed information.

19. A computer-executable program for controlling an information receiving terminal that accesses a server on a network, based on information received from an information transmitter having information relating to a particular article, said program comprising:
a first step of issuing a request to said information transmitter to send information through a communication means;
a second step of immediately accessing said server upon receiving the server access address from said information transmitter;
a third step of acquiring posted information about said article from said server; and
a fourth step of transferring said acquired posted information to an information-presenting unit,
wherein the first, second, and third steps are performed in a processing sequence.

20. A method for providing product information, using a storage device that is able to transmit information stored thereon and can be attached to a product, said method comprising the steps of:
storing product identifying information and information for accessing a product information server into said storage device;
upon request from a terminal device to read information from said storage device, transferring said product identifying information to the terminal device;
making said terminal device access said product information server;
distributing product information from said product information server to said terminal device; and
storing information identifying said terminal device into said product information server, so that said product information server can access said terminal device.
